(19) United States
(12) Patent Application Publication
(10) Pub. No.: US 2002/0023198 A1
(43) Pub. Date: Feb. 21, 2002

(54) Information processing apparatus and data backup method

(76) Inventors: Tomoyuki Kokubun, Ome-shi (JP); Atsushi Watanabe, Ome-shi (JP)

Correspondence Address: Finnegan, Henderson, Farabow, Garrett & Dunner, L.L.P., 1300 I Street, N.W., Washington, DC, 20005-3315, US

(21) Appl. No.: 09/899,216

(22) Filed: Jul. 6, 2001

(30) Foreign Application Priority Data
Jul. 7, 2000 (JP) 2000-207447

(51) Int. Cl. G06F 13/00

(52) U.S. Cl. 711/162; 711/115

(57) ABSTRACT

A detachable second hard disk device is used to back up data written in a first hard disk device which is mounted in a personal computer, and when the second hard disk device is connected, the contents of data written in the first hard disk device is also written in the second hard disk device. When the second hard disk device is not connected, the contents of data written in the first hard disk device are stored in a change log, and when the second hard disk device is connected, the contents of the data write stored in the change log are backed up to the second hard disk device, thus synchronizing the contents of the first and second hard disk devices. After that, a normal backup process using the second hard disk device restarts.

### CROSS-REFERENCE TO RELATED APPLICATIONS

This application is based upon and claims the benefit of priority from the prior Japanese Patent Application No. 2000-207447, filed Jul. 7, 2000, the entire contents of which are incorporated herein by reference.

### BACKGROUND OF THE INVENTION

The present invention relates to an information processing apparatus suitable for backing up data in a portable personal computer, a data backup method, and a storage medium that stores a data backup program.

In general, mirroring is known as one of methods for restoring data when a hard disk device has failed. In mirroring, two hard disk devices are prepared, and identical contents are simultaneously written in the two hard disk devices upon writing data. When data on one hard disk device are destroyed and cannot be read out, data can be immediately read out (recovered) by replacing the destroyed hard disk device by the other hard disk device. As other methods devised to cope with hard disk troubles, duplexing, file backup for respective files (a method of backing up only files that have been modified after a specific date & time), and the like are used in addition to mirroring.

When mirroring is done based on the conventional data backup method, two hard disk devices must always be prepared. Conventionally, a system for backing up data using mirroring is normally applied to relatively large-scale systems such as a server apparatus and the like, and mirroring is executed using two fixed hard disk devices.

A portable information processing apparatus, e.g., a note book type personal computer, has a single hard disk device. Upon mirroring, since identical contents need be simultaneously written in two hard disk devices, the conventional portable personal computer cannot back up data by mirroring. In a personal computer, a hard disk device can be expanded by means of a docking station, selectable bay, or USB (Universal Serial Bus)/IEEE1394 connection. However, since such expanded hard disk device is detachable, it cannot be used in mirroring.

Especially, it is not practical to always connect a hard disk device for storing backup data to a portable personal computer, since the portability of the personal computer is impaired. Two hard disk devices may be mounted in a personal computer, and one of them may be used for data backup. However, such an arrangement leads to an increase in the size of the apparatus, and impairs portability.

When a backup method (file backup or the like) in which a backup hard disk device need not always be connected is used, the portability of a personal computer can be assured. However, the user must routinely launch a backup application and designate another storage device or storage media as a copy (backup) destination of files and data to be backed up. For example, when an external hard disk device is used as a backup storage device, the user designates that external hard disk device as a backup destination. However, when the user has a plurality of external hard disk devices, and a hard disk device which is not used for backup is connected, since designation of the backup destination remains the same, data may be backed up on the hard disk device which is not used for backup. Also, when a specific storage medium is used as the backup destination, and the user loads the wrong storage medium which is not used for backup into a storage device, data backup is executed on that storage medium.

Conventionally, the user must launch the backup application, and even when a storage device connected to the personal computer (or a loaded storage medium) is not for backup, backup is executed in a wrong destination in accordance with the backup destination designated by the user.

### BRIEF SUMMARY OF THE INVENTION

It is, therefore, an object of the present invention to provide an information processing apparatus and data backup method, which can easily back up data on a storage device, which is easily detachable, in place of any fixed data backup storage device without mistaking a backup destination.

According to the first aspect of the present invention, there is provided an information processing apparatus which mounts a first storage device, and to which a second storage device for data backup is connectable, the apparatus comprising: detection unit detecting whether or not the second storage device is connected; storage unit storing latest contents of a data write with respect to the first storage device, when the detection unit detects that the second storage device is not connected; and backup control unit backing up the contents of the data write with respect to the first storage device, which are stored by the storage unit, to the second storage device, and thereafter backing up contents of another data write with respect to the first storage device to the second storage device, when the detection unit detects that the second storage device is connected.

The information processing apparatus may further comprise setting unit setting if a process for backing up the contents stored by the storage unit to the second storage device is executed instantaneously when the detection unit detects that the second storage device is connected.

The information processing apparatus may further comprise: collation information recording unit recording in advance, in the second storage device, collation information indicating that the second storage device is used as a data backup device; and discrimination unit discriminating based on the collation information recorded in the second storage device if the connected storage device is the second storage device for data backup, when the detection unit detects that the second storage device is connected, and wherein when the discrimination unit discriminates that the connected second storage device is a data backup device, the backup control unit backs up data stored in the first storage device to that second storage device.

According to the second aspect of the present invention, there is provided a data backup method for backing up data written in a first storage device to a second storage device in an information processing apparatus to which the second storage device for data backup can be connected in addition to the first storage device which is mounted in advance, comprising the steps of: storing, when the apparatus is not ready to back up since the second storage device is not connected, contents of a data write with respect to the first storage device; and backing up, when it is determined that the second storage device is connected, the stored contents of the data write with respect to the first storage device to the second storage device, and thereafter backing up contents of another data write with respect to the first storage device to the second storage device.

The data backup method further comprises the steps of: storing, when the contents of the data write with respect to the first storage device are stored, change information indicating that contents have been changed by the data write with respect to the first storage device; and immediately executing, when it is determined that the second storage device is connected, and if the change information is not stored, a backup process to the second storage means.

The data backup method further comprises the steps of: recording in advance, in the second storage device, collation information indicating that the second storage device is used as a backup device; discriminating, when it is determined that the second storage device is connected, based on the collation information recorded in the second storage device if the connected storage device is the second storage device for data backup; and backing up, when it is discriminated that the connected second storage device is a data backup device, backing up the stored contents of the data write with respect to the first storage device to the second storage device, and thereafter backing up contents of another data write with respect to the first storage device to the second storage device.

According to the third aspect of the present invention, there is provided an information processing apparatus which mounts a first storage device, and to which a second storage device for data backup is connected, comprising: collation information recording means for recording in advance, in an arbitrarily connectable second storage device, collation information indicating that the second storage device is used as a data backup device; detection means for detecting if the second storage device is connected to the information processing apparatus; discrimination means for, when the detection means detects that the second storage device is connected, discriminating based on the collation information recorded in the second storage device if the connected storage device is the second storage device for data backup; and backup means for, when the discrimination means discriminates that the connected second storage device is a data backup device, backing up data stored in the first storage device to the second storage device.

In the information processing apparatus, the second storage device can arbitrarily load/unload a storage medium, and the collation information recording means may record the collation information in the storage medium loaded into the second storage device.

According to the fourth aspect of the present invention, there is provided a data backup method for backing up data written in a first storage device to a second storage device in an information processing apparatus to which the second storage device for data backup can be connected in addition to the first storage device which is mounted in advance, comprising the steps of: recording in advance, in the second storage device, collation information indicating that the second storage device is used as a data backup device; discriminating, when it is detected that the second storage device is connected to the information processing apparatus, based on the collation information recorded in the second storage device if the connected storage device is the second storage device for data backup; and backing up, when it is discriminated that the connected second storage device is a data backup device, data stored in the first storage device to the second storage device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIGS. 1A and 1B are perspective views showing the outer appearance of a system (a personal computer 10 and docking station 12) according to an embodiment of the present invention;

FIG. 2 is a block diagram showing the arrangement of principal part of the personal computer 10 in the embodiment of the present invention;

FIG. 3 is a flow chart for explaining the operation executed when a data write request to a hard disk device 24 in the personal computer 10 has been issued in the first embodiment;

FIG. 4 is a flow chart for explaining an instantaneous synchronization setup operation in the first embodiment;

FIG. 5 shows an example of a dialog box used when the instantaneous synchronization setup is made in the first embodiment;

FIG. 6 is a flow chart for explaining the operation of a backup program 22b when a hard disk device 16 (HDD2) is connected in the first embodiment;

FIG. 7 is a flow chart for explaining the operation executed when the hard disk device 16 (HDD2) is detached in the first embodiment;

FIGS. 8A and 8B show examples of a change log 22d;

FIGS. 9A to 9D are views showing an example for explaining the mirroring method in the first embodiment;

FIG. 10 is a flow chart for explaining an initial setup process of the backup program 22b in the second embodiment;

FIG. 11 is a flow chart for explaining the operation of the backup program 22b when the hard disk device 16 is connected to the personal computer 10 in the second embodiment;

FIG. 12 is a schematic diagram of a system which uses an external storage device 33 which allows to arbitrarily exchange storage media 34a, 34b, 34c, . . . in the second embodiment;

FIG. 13 is a flow chart for explaining the operation of the backup program 22b in the system shown in FIG. 12;

FIG. 14 is a flow chart for explaining the operation of the backup program 22b in the third embodiment; and

FIG. 15 is a view for explaining the backup procedure storage device with a communication function.

### DETAILED DESCRIPTION OF THE INVENTION

Preferred embodiments of the present invention will be described hereinafter with reference to the accompanying drawings.

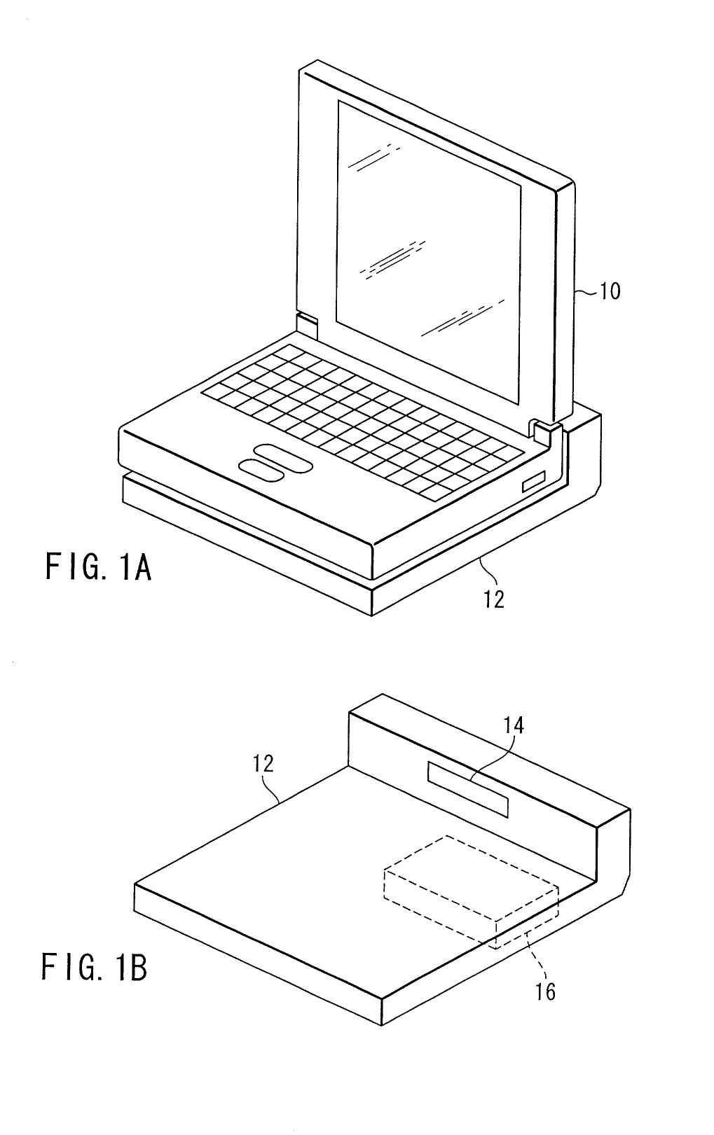

FIGS. 1A and 1B show the outer appearance of a system according to an embodiment of the present invention, i.e., a state wherein a personal computer 10 is mounted on a docking station 12. The personal computer 10 is realized by a portable type (note book type in the example shown in FIGS. 1A and 1B) computer, the operation of which is controlled by a program loaded from a recording medium such as a CD-ROM, DVD, magnetic disk, or the like. The docking station 12 is used to expand various functions with respect to the personal computer 10, and is connected to the personal computer 10 via expansion connectors 14 which are provided to both the personal computer 10 and docking station 12. The docking station 12 mounts various functions, one of which is an expansion hard disk device 16. When the personal computer 10 is connected to the docking station 12, it can use the hard disk device 16 (HDD2 (second storage device)) as well as its internal hard disk device 24 (HDD1 (first storage device)) (to be described later) which is mounted in advance.

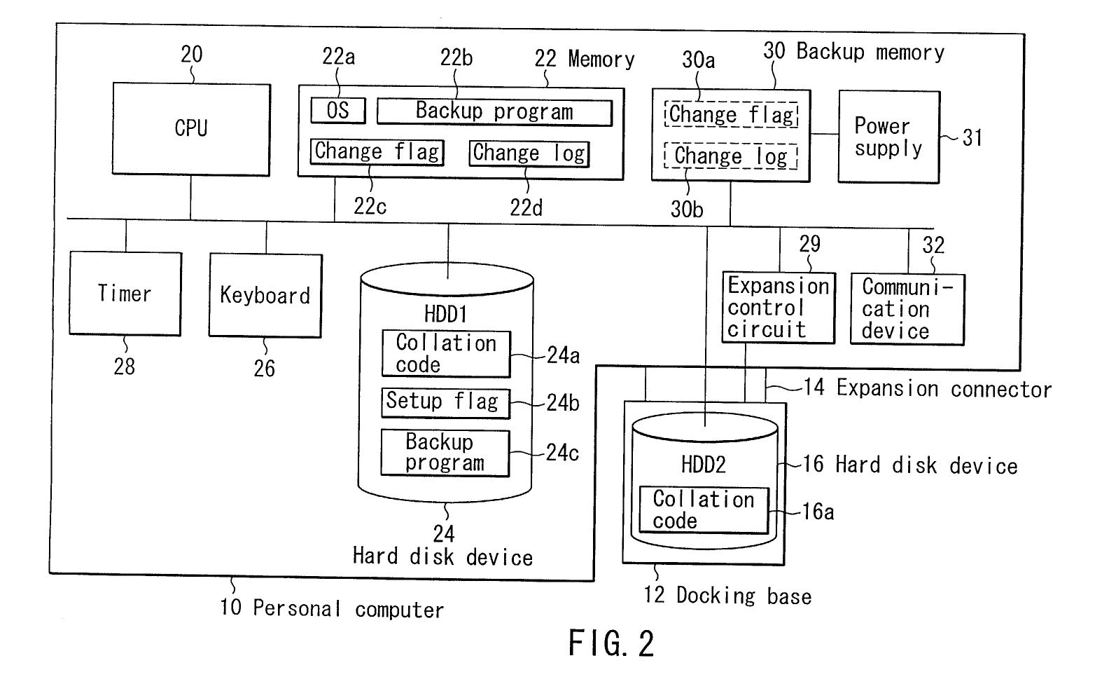

FIG. 2 is a block diagram showing the arrangement of principal part of the personal computer 10. As shown in FIG. 2, the personal computer 10 comprises a CPU 20, a memory 22, the hard disk device 24, a keyboard 26, a timer 28, an expansion control circuit 29, a backup memory 30, a power supply 31, and a communication device 32 in addition to a display, pointing device, and the like (not shown).

The CPU 20 controls the operation of the personal computer 10 by executing various programs stored in the memory 22. The memory 22 stores a backup program 22b, a communication program (including a device driver for the communication device 32), and the like in addition to an operating system (OS) 22a stored in and read out from the hard disk device 24. The backup program 22b implements a function of backing up data to be written in the hard disk device 24 to another expanded hard disk device, e.g., the hard disk device 16 mounted in the docking station 12 (detailed processing contents will be described later). Assume that the backup program 22b resides if it is installed. The memory 22 stores change information, i.e., a change flag 22c and change log 22d, which are used in the process of the backup program 22b and indicate if the contents of the hard disk device 16 have been changed. The change flag 22c indicates that a data write to the hard disk device 16 has been made when the contents of data written in the hard disk device 24 are not backed up using the hard disk device 16, i.e., that the contents of data stored in the hard disk devices 16 and 24 are not synchronized (not identical). The change log 22d stores the latest contents (changed write position, write data, and the like) of data written in the hard disk 16 when the contents of data written in the hard disk device 24 are not backed up using the hard disk device 16. For example, the change log 22d is a bitmap file which stores data indicating the presence/absence of data writes for respective predetermined data write units with respect to the hard disk device 24 (see FIG. 8A). As the predetermined unit, an arbitrary one of a sector, a plurality of sectors, a track, and the like may be used. If a data write has been made for such a unit, a corresponding bit of the log is set ON (“1”); otherwise, OFF (“0”). Also, the change log 22d is a log file that stores the data write position and write data with respect to the hard disk device 24 in correspondence with each other (see FIG. 8B).

Note that the change flag 22c and change log 22d may be stored in another backed-up storage unit different from the memory 22 that stores the operating system 22a and backup program 22b, and their storage contents may be protected from being easily destroyed. For example, the backup memory 30 may be provided independently of the memory 22, and may store a change flag 30a and change log 30b. The backup memory 30 is supplied with electric power from the power supply 31 all the time, and can hold the stored data even when the apparatus is OFF. Therefore, even when data stored in the memory 22 are lost due to, e.g., locking-up or hanging, the change flag 30a and change log 30b stored in the backup memory 30 can be prevented from being lost. Note that the backup memory 30 may use a nonvolatile storage medium.

The expansion control circuit 29 monitors the attachment/detachment state of the docking station 12, and detects attachment/detachment on the basis of an attachment/detachment detect signal, connection detect signal, and the like supplied from the docking station 12 via the expansion connectors 14. The expansion control circuit 29 sends to the CPU 20 (operating system 22a) a message of an event generated in accordance with the attachment/detachment state.

The communication device 32 makes wireless communications via infrared rays or a radio wave under the control of the CPU 20. The communication device 32 has a function of establishing a communication link with another communication device by recognizing each other when the apparatus moves to fall within a wireless communication range with the other communication device. The communication device 32 makes wireless communications using, e.g., Bluetooth.

The hard disk device 16 mounted in the docking station 12 can be used as a normal external storage device as well as the internal hard disk device 24 of the personal computer 10 when the personal computer 10 is connected to the docking station 12. However, when the backup program 22b is installed, and sets the hard disk devices 24 and 16 as master and slave storage devices, respectively, the hard disk device 16 is used as a backup storage device of the hard disk device 24. When collation information (details will be explained later) is recorded in the hard disk devices 24 and 16 by the function of the backup program 22b, the hard disk device 16 that records the collation information is used as a dedicated backup storage device of the hard disk device 24. Conventionally, when the expanded hard disk device is used as a data backup device, especially, when mirroring is executed, the backup hard disk device cannot be detached. However, in the personal computer 10 of this embodiment (function implemented by the backup program 22b), mirroring can continue even when the personal computer 10 is arbitrarily detached from the docking station 12, thus assuring portability of the personal computer 10. Since collation information (collation codes 24a and 16a) is recorded in the hard disk devices 24 and 16, when another hard disk device that does not record any collation code 16a is connected, a backup process is never erroneously executed for this hard disk device.

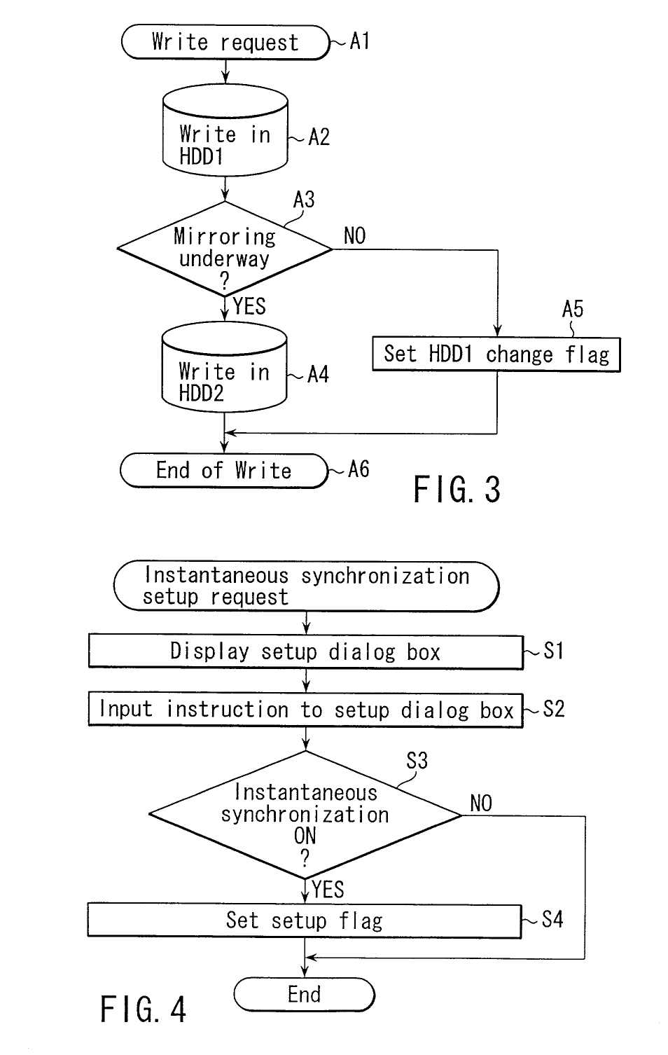

The operation in the first embodiment of the present invention will be described below with reference to the flow charts shown in FIGS. 3, 4, 6, and 7. The first embodiment will describe a backup method in which while the hard disk device 16 set as a backup destination is not connected, the contents of data written in the hard disk device 24 are stored, and when the hard disk device 16 is connected, the stored contents of write data are backed up in the hard disk device 16. In this embodiment, a case will be exemplified wherein mirroring is executed as a data backup process.

The operation executed when a data write request with respect to the hard disk device 24 has been issued in the personal computer 10 will be explained below with reference to the flow chart shown in FIG. 3.

If the operating system 22a generates a write request with respect to the hard disk device 24 upon executing various application programs (step A1), the backup program 22b writes data in the hard disk device 24 (HDD1) in a mirroring process (step A2).

The backup program 22b checks if mirroring using the hard disk device 16 in the docking station 12 is underway (step A3). If the personal computer 10 is not connected to the docking station 12, it is determined that mirroring is not underway. On the other hand, even when the personal computer 10 is connected to the docking station 12 and is ready to access the hard disk device 16, if the backup program 22b is not set to execute synchronization instantaneously at the time of connection of the hard disk device 16 for mirroring, and no mirroring start instruction is input, it is also determined that mirroring is not underway. Note that details of the setup for executing synchronization instantaneously (setup of instantaneous synchronization) and the mirroring start instruction will be described later.

If it is determined as a result of this checking that mirroring is underway, the backup program 22b executes mirroring by writing data identical to the data written in the hard disk device 24 at an identical position of the hard disk device 16 of the docking station 12 (step A4).

On the other hand, if it is determined in step A3 that mirroring is not underway, the backup program 22b sets a change flag 22c to indicate that the contents of data stored in the hard disk devices 16 and 24 are not synchronized (not identical) (step A5). With this flag, when the program is ready to execute mirroring, it is determined that the stored data contents must be synchronized between the hard disk devices 16 and 24. Also, the backup program 22b stores the data write contents in a change log 22d in the bitmap format shown in, e.g., FIG. 8A, in accordance with data written in the hard disk device 24. In the example shown in FIG. 8A, a bit corresponding to a position (e.g. a sector) changed by a data write is set at “1” to store the data write contents.

Note that the change log 22d in the bitmap file format shown in FIG. 8A is used to store the data write contents. Alternatively, the data write position and write data itself may be stored as log data, as shown in FIG. 8B. The change log 22d shown in FIG. 8B includes the write position of data written in the hard disk device 24, the data size of the write data, the write data itself, and link data indicating the location of log data associated with data written next to that write data. In this case, upon synchronizing the contents of the hard disk devices 24 and 16, write data corresponding to that at the data write position is written in the hard disk device 16 at the position indicated by the data write position.

The instantaneous synchronization setup process for executing synchronization instantaneously at the time of connection of the hard disk device 16 for mirroring will be explained below with reference to the flow chart shown in FIG. 4.

The instantaneous synchronization setup sets if a backup process for storing the data write contents with respect to the hard disk device 24 while mirroring is not executed in the hard disk device 16 is executed instantaneously when it is detected that the hard disk device 16 is connected (the personal computer 10 is mounted on the docking station 12), and can be arbitrarily set in accordance with a user's instruction.

If an instantaneous synchronization setup request is input by user's operation at the keyboard 26, the backup program 22b displays an instantaneous synchronization setup window (dialog box) on the display (step S1).

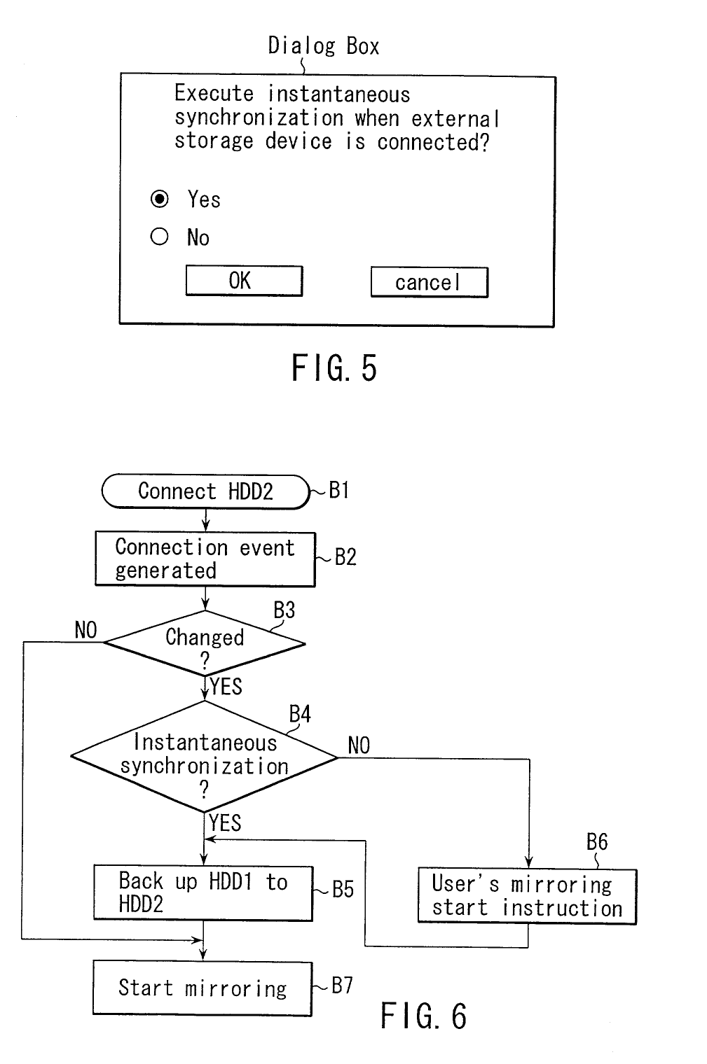

FIG. 5 shows an example of the dialog box used in the instantaneous synchronization setup. The instantaneous synchronization setup dialog box includes radio buttons used to designate whether or not instantaneous synchronization is executed, and one of “execute instantaneous synchronization” (“instantaneous synchronization ON”) or “not execute instantaneous synchronization (“instantaneous synchronization OFF”) can be arbitrarily selected.

When a designation is input to the dialog box shown in FIG. 5 (step S2), and completion of setup is designated using an “ok” button, if “instantaneous synchronization ON” is selected (step S3), the backup program 22b sets a setup flag 24b stored in the hard disk device 24 ON so as to indicate to execute instantaneous synchronization (step S4).

The setup flag 24b set by the instantaneous synchronization setup process is referred to when an event indicating connection of the hard disk device 16 is generated.

The operation executed when the hard disk device 16 (HDD2) is connected (the personal computer 10 is connected to the docking station 12) will be explained below with reference to the flow chart shown in FIG. 6.

If the personal computer 10 is connected to the docking station 12 (step B1), the expansion control circuit 29 sends to the operating system 22a a message indicating generation of a connection event. When the operating system 22a detects connection of the hard disk device 16 based on that message from the expansion control circuit 29, it sends to the backup program 22b a message indicating connection of the hard disk device 16 for mirroring.

Upon receiving the message from the operating system 22a (step B2), the backup program 22b checks with reference to the change flag 22c if data stored in the hard disk device 24 have been changed after the hard disk device 16 was disconnected previously (the personal computer 10 was detached from the docking station 12) (step B3).

If data stored in the hard disk device 24 have not been changed, the backup program 22b starts mirroring using the hard disk device 16. That is, the backup program 22b writes data identical to that written in the hard disk device 24 at an identical location of the hard disk device 16 of the docking station 12.

On the other hand, if data stored in the hard disk device 24 have been changed, the backup program 22b checks with reference to the setup flag 24b if instantaneous synchronization is set (step B4).

If “instantaneous synchronization ON” is set, the backup program 22b copies corresponding data stored in the hard disk device 24 to a predetermined location of the hard disk device 16 in accordance with the data write contents stored in the change log 22d, thus synchronizing the hard disk devices 24 and 16 (making them store identical data) (step B5).

When the change log 22d shown in FIG. 8A is used, data at a position (sector) set with “1” in the change log 22d is copied to the corresponding sector position of the hard disk device 16. Upon completion of synchronization, the contents stored in the change log 22d are cleared (all “0”s).

When the change log 22d shown in FIG. 8B is used, write data corresponding to data at the data write position is copied to a position of the hard disk device 16 indicated by data of the data write position. The backup program 22b copies write data to the hard disk device 16 in turn while tracking log data on the basis of link data.

On the other hand, if “instantaneous synchronization OFF” is set, the backup program 22b does not execute mirroring until it receives a mirroring start instruction from the user or a mirroring start timing scheduled in advance is reached (step B6). Note that the mirroring start schedule is arbitrarily set in accordance with a user's instruction upon, e.g., setting “instantaneous synchronization OFF”. For example if the radio button “instantaneous synchronization OFF” is selected in the dialog box shown in FIG. 5, the backup program 22b displays a dialog box for setting a mirroring start schedule on the display, and prompts the user to input an instruction from the dialog box.

In this way, when the user does not want to reflect the contents stored in the hard disk device 24 in the hard disk device 16, he or she sets the backup program 22b of this embodiment to “instantaneous synchronization OFF” so as to intentionally save the state before the hard disk device 24 has undergone a write in the hard disk device 16. In this manner, when the operation of the personal computer 10 may become unstable upon installing a new application program or when unnecessary data may be generated in a large quantity, “instantaneous synchronization OFF” is set to save the state before change in the hard disk device 16, and an original state can be easily restored using the hard disk device 16.

Upon receiving a mirroring start instruction from the user (or in accordance with a schedule) while “instantaneous synchronization OFF” is set, the backup program 22b copies corresponding data stored in the hard disk device 24 to a predetermined location of the hard disk device 16 in accordance with the data write contents stored in the change log 22d, thus synchronizing the hard disk devices 24 and 16 (step B5). Upon completion of synchronization, the program 22b starts mirroring (step B7).

In this fashion, when the hard disk device 16 is ready to use upon attaching the personal computer 10 to the docking station 12, the contents of data written in the hard disk device 24 while mirroring is not executed are copied (backed up) to the hard disk device 16 on the basis of the change log 22d, thus synchronizing data stored in the hard disk devices 24 and 16. After that, mirroring can be restarted. On the other hand, when “instantaneous synchronization OFF” is set, a synchronization process can be executed at an arbitrary timing after the hard disk device 16 is connected.

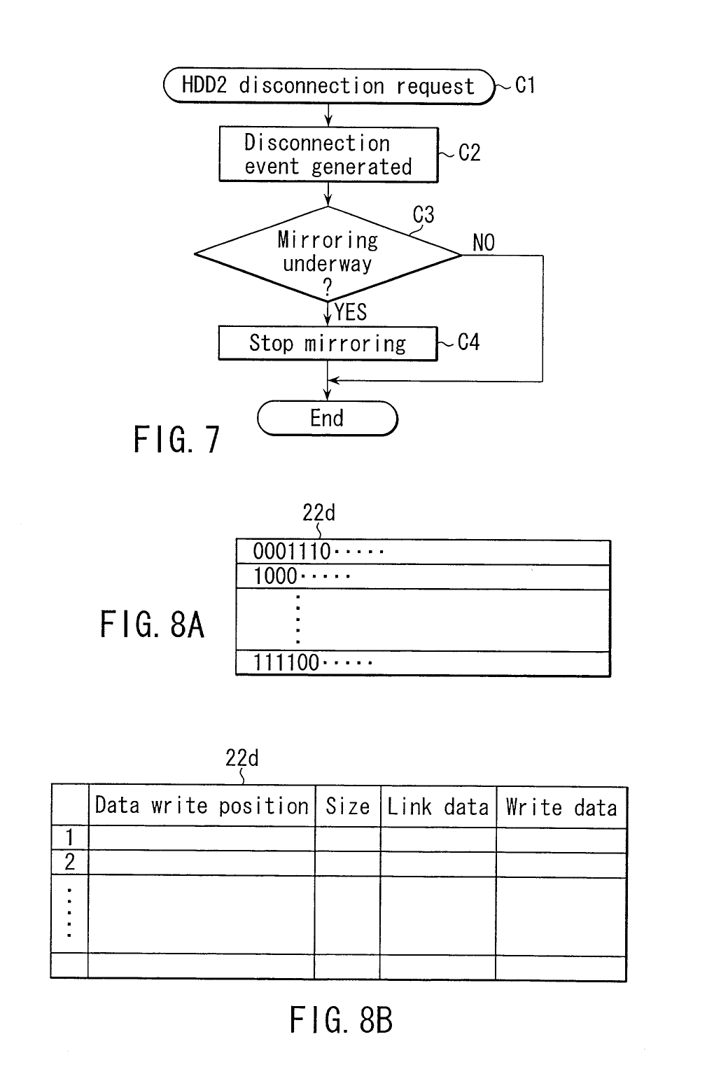

The operation executed when the hard disk device 16 (HDD2) is detached (the personal computer 10 is detached from the docking station 12) will be explained below with reference to the flow chart shown in FIG. 7.

If the personal computer 10 is detached from the docking station 12 (step Cl), the expansion control circuit 29 sends to the operating system 22a a message indicating a detachment event. Upon detecting detachment of the hard disk device 16 based on that message from the expansion control circuit 29, the operating system 22a sends to the backup program 22b a message indicating that the hard disk device 16 for mirroring is detached.

Upon receiving the message from the operating system 22a (step C2), the backup program 22b checks if mirroring is underway (step C3). If mirroring is underway, the backup program 22b stops mirroring according to a data write with respect to the hard disk device 24 (step C4). The backup program 22b sets the change flag 22c with respect to a data write to the hard disk device 24 generated after mirroring is stopped, and stores the data write contents in the change log 22d in accordance with data written in the hard disk device 24 (see FIG. 3).

In this manner, even when the hard disk device 16 used in mirroring is arbitrarily detached, the contents of data writes made while mirroring is not executed are stored in the change log 22d, and the contents of the hard disk device 24 can be reflected in the hard disk device 16 in accordance with the flow chart shown in FIG. 6 upon next connection of the hard disk device 16.

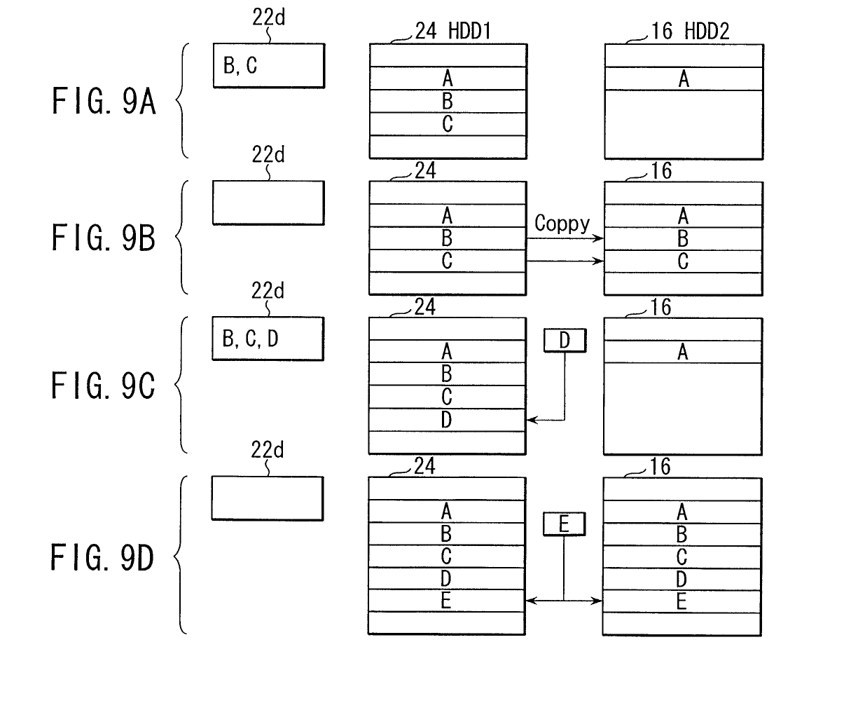

The aforementioned mirroring method will be explained below using a simple example shown in FIGS. 9A to 9D.

When data A is written in the hard disk device 24 during mirroring, data A is similarly written in the hard disk device 16. When data B and C are written in the hard disk device 24 after the hard disk device 16 is detached, write events of data B and C are stored in the change log 22d, as shown in FIG. 9A.

In this case, when “instantaneous synchronization ON” is set, if the hard disk device 16 is connected, data B and C stored in the hard disk device 24 are copied to predetermined locations of the hard disk device 16 in accordance with the contents of the change log 22d, as shown in FIG. 9B, thus synchronizing the contents of the two hard disk devices.

On the other hand, when “instantaneous synchronization OFF” is set, even if the hard disk device 16 is connected, the two hard disk devices are not synchronized. When data D is written in the hard disk device 24, a write event of data D is stored in the change log 22d, as shown in FIG. 9C. In this case, upon receiving a mirroring execution instruction from the user, data B, C, and D are copied to the hard disk device 16 on the basis of the data stored in the change log 22d to synchronize contents of the two hard disk devices. After that, when data E is written in the hard disk device 24, data E is similarly written in the hard disk device 16, as shown in FIG. 9D, thus executing mirroring.

In this way, when the contents of the internal hard disk device 24 of the personal computer 10 are backed up by mirroring using the hard disk device 16 mounted in the docking station 12, mirroring can continue even when the personal computer 10 is arbitrarily detached from the docking station 12. Therefore, the portability of the personal computer 10 can be assured, and the user can carry the personal computer 10 with a lightweight arrangement. When the user brings back the personal computer 10, he or she need only connect the personal computer 10 to the docking station 12 to execute mirroring for the hard disk device 24 (when “instantaneous synchronization ON” is set). Hence, the user can conserve data written in the hard disk device 24 without any action.

In the above description, mirroring in the personal computer 10 has been exemplified. Alternatively, the present invention can be applied to data backup for respective files. For example, when a file stored in the hard disk device 24 has been rewritten while the hard disk device 16 is not connected, the rewritten file is stored in the change log 22d, and when the personal computer 10 is connected to the docking station 12, the rewritten file is copied to the hard disk device 16 on the basis of the change log 22d, thus backing up that file.

In the above description, the change flag 22c and change log 22d are stored. If it is checked based on the change log 22d if the contents of data stored in the hard disk device 24 have been changed while the hard disk device 16 is not connected, the change flag 22c may be omitted.

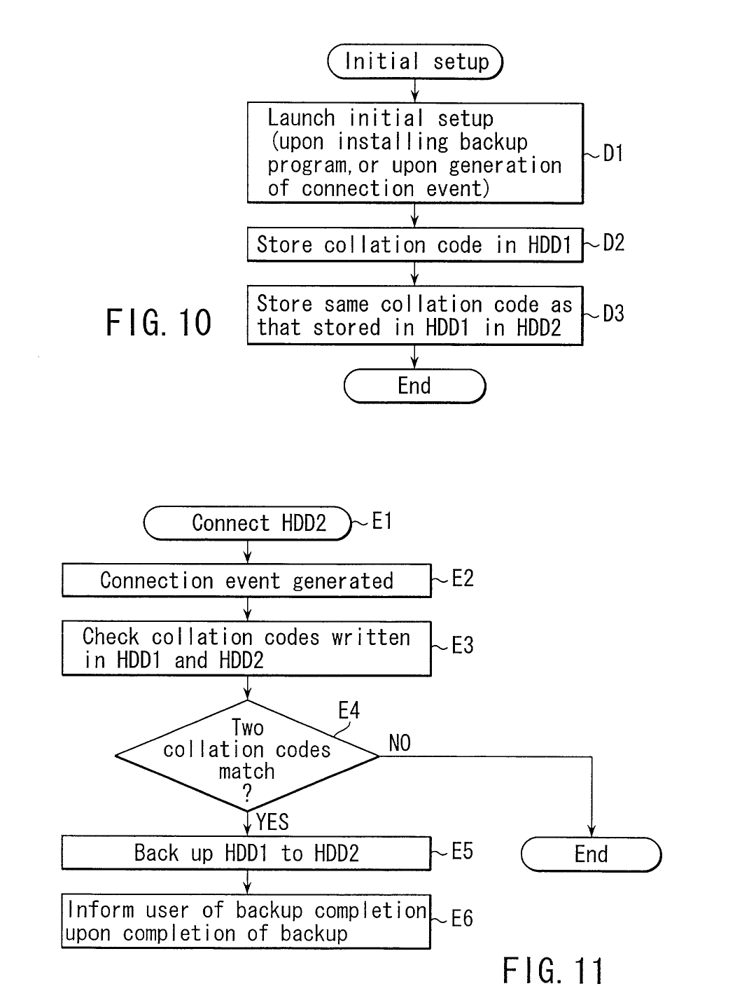

The operation according to the second embodiment of the present invention will be described below with reference to the flow charts shown in FIGS. 10 and 11. In the second embodiment, since collation codes are recorded in the hard disk device 24 as a backup source and the hard disk device 16 as a backup destination, when the hard disk device 16 recorded with this collation code is connected, backup is executed for this hard disk device 16. In this embodiment, file backup will be exemplified as data backup.

The initial setup process of the backup program 22b will be described below using the flow chart shown in FIG. 10.

Assume that the initial setup process of the backup program 22b is executed when the backup program 22b is installed in the hard disk device 24 or when the hard disk device 16 is connected to the personal computer 10 for the first time (upon generation of a connection event) (step Dl).

Upon executing data backup of the hard disk device 24 (HDD1), the backup program 22b records a collation code 24a in the hard disk device 24 (HDD1) as a backup source (step D2), and stores an identical collation code 16a in a storage device set as a backup destination (the hard disk device 16 (HDD2) in this case). (step D3). The collation code is data indicating that the hard disk device 16 is used for data backup.

After the backup program 22b is installed, the backup program may be launched at an arbitrary timing in accordance with the user's instruction, and a collation code may be arbitrarily stored in a connected storage device by the function of the backup program 22b. After the collation code is stored in the hard disk device 16, even when the hard disk device 16 is detached from an external interface 11, it is detected upon next connection that the hard disk device 16 is a data backup device.

Note that objects to be backed up in the hard disk device 24 can be set in advance in accordance with the user's designation by the function of the backup program 22b. For example, a specific file or folder may be set as an object to be backed up, or data changed after a specific date & time may be set as an object to be backed up. Information indicating objects to be backed up set by the backup program 22b is stored in the hard disk device 24 (or memory 22), and is referred to as needed.

The operation of the backup program 22b executed when the hard disk device 16 is connected to the personal computer 10 via the external interface 11 will be described below with reference to the flow chart shown in FIG. 11.

If the hard disk device 16 is connected to the personal computer 10 (step El), the operating system 22a sends to the operating system 22a a message indicating generation of a connection event. Upon detecting the connection event, the operating system sends to the backup program 22b a message indicating connection of the hard disk device 16.

Upon receiving the message from the operating system 22a (step E2), the backup program 22b reads out and confirms the collation codes 24a and 16a respectively stored in the hard disk devices 24 and 16 (step E3) and checks if the two collation codes match (step E4).

If the backup program 22b cannot read out any collation code from the hard disk device 16 or if the collation code 16a read out from the hard disk device 16 does not match the collation code 24a of the hard disk device 24, the backup program 22b determines that the connected hard disk device 16 is not a backup device for the hard disk device 24, and ends the process.

On the other hand, if the collation code 16a of the hard disk device 16 matches the collation code 24a of the hard disk device 24, the backup program 22b backs up data (file) to be backed up written in the hard disk device 24 to the hard disk device 16 (step E5).

Upon completion of backup, the backup program 22b displays, e.g., a backup end message for the user on the display (not shown) (step E6).

In this manner, since the collation code 16a is stored in the hard disk device 16 set as a backup destination, even when the user connects a wrong hard disk device (docking base in this embodiment), no backup process is executed for that hard disk device. only when a hard disk device 16 stored with a collation code 16a is connected, the backup process is executed. Since the backup process automatically starts by only connecting the hard disk device 16 stored with the collation code 16a to the personal computer 10, the user need not launch the backup program 22b. Hence, since the user need not have any knowledge about the operation of the backup program 22b, the load on the user can be reduced.

In the above description, the hard disk device 16 whose storage medium is fixed is used as a backup destination. Alternatively, an external storage device which allows to arbitrarily exchange storage media can be used as a backup destination, as will be described below.

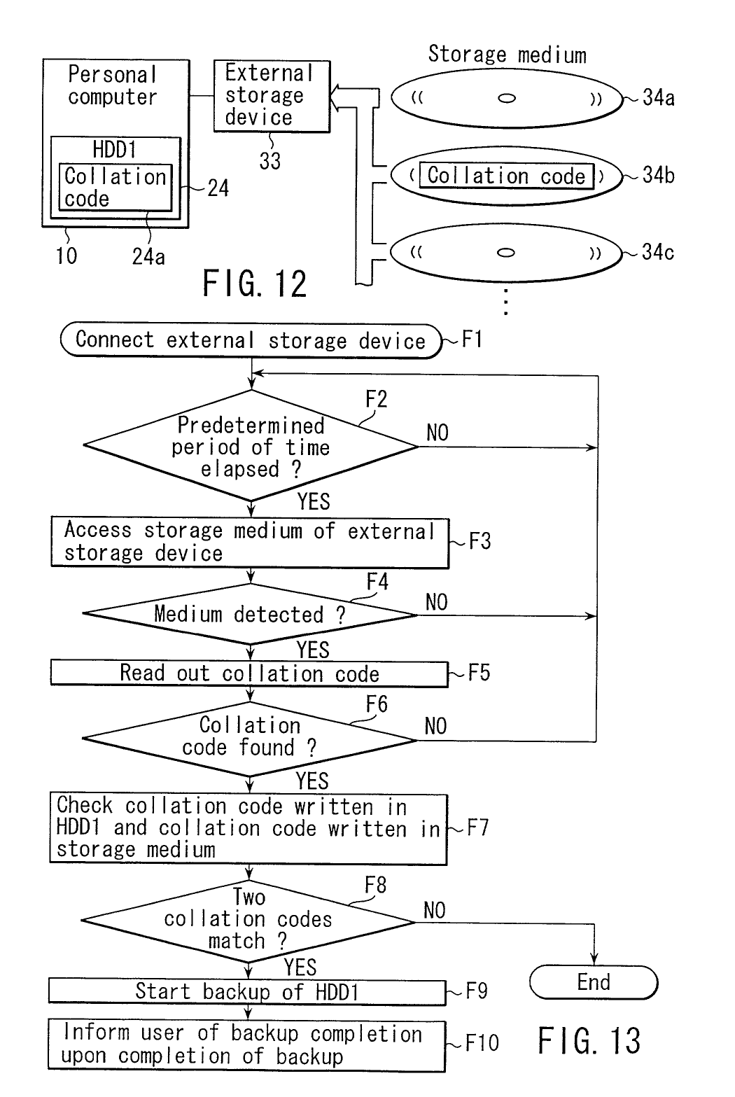

FIG. 12 is a schematic diagram of a system using an external storage device 33 which allows to arbitrarily exchange storage media 34a, 34b, 34c, The storage media 34a, 34b, 34c, can be arbitrarily loaded/unloaded to/from the external storage device 33. For example, when the aforementioned initial setup process of the backup program 22b shown in FIG. 10 is executed upon loading a specific storage medium 34b, the storage medium 34b can be set as a backup destination of the hard disk device 24. That is, identical collation codes can be stored in the hard disk device 24 and storage medium 34b.

The operation of the backup program 22b in the system using the external storage device 33 that allows to arbitrarily exchange storage media 34a, 34b, 34c, will be described below with reference to the flow chart shown in FIG. 13.

After the external storage device 33 is connected to the personal computer 10 (step Fl), the backup program 22b makes the external storage device 33 access the storage medium via the operating system 22a (step F3) every time a predetermined period of time elapses (step F2). That is, since the operating system 22a does not have any function of directly detecting loading/unloading of the storage medium in the external storage device 32, loading/unloading is detected by periodically accessing the storage medium. If the operating system 22a has a function of directly detecting loading/unloading of the storage medium in the external storage device 32, the processes in steps F2 and F3 can be omitted by exploiting this function.

If it is detected that the storage medium is loaded into the external storage device 33, the operating system 22a sends to the backup program 22b a message indicating that the storage medium is loaded. Upon receiving this message from the operating system 22a (step F4), the backup program 22b reads out the collation code 24a stored in the hard disk device 24, and a collation code stored in the storage medium loaded into the external storage device 32 (step F5). If any collation code cannot be read out from the storage medium, the backup program 22b determines that the storage medium loaded into the external storage medium 32 is not a backup medium, and ends the processing (step F6).

On the other hand, if the collation code is read out from the storage medium, the backup program 22b checks if the collation code 24a stored in the hard disk device 24 matches the collation code stored in the storage medium (step F7). As a result, if the two collation codes match (step F8), the backup program 22b begins to back up data (file) to be backed up written in the hard disk device 24 to, e.g., the storage medium 34b loaded into the external storage device 33 (step F9).

Upon completion of backup, the backup program 22b, for example, displays a backup end message to the user on the display (not shown) (step F10).

In this way, since a collation code is stored in the storage medium set as a backup destination, even when the user inserts a wrong storage medium as a backup destination into the external storage device 33, no backup process is executed for this storage medium, and only when the storage medium 34b that stores the collation code is loaded, the backup process is executed. Since the backup process automatically starts by only inserting the storage medium 34b that stores the collation code into the external storage medium 33, the user need not launch the backup program 22b. Hence, since the user need not have any knowledge about operation of the backup program 22b, the load on the user can be reduced.

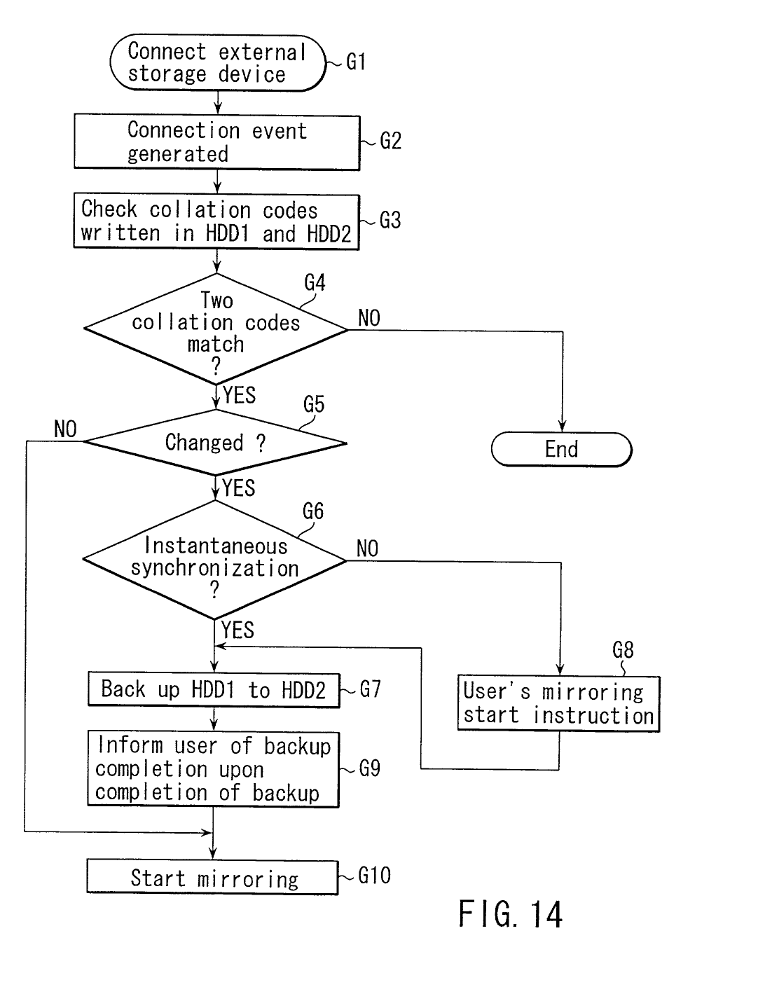

The third embodiment of the present invention will be described below. The third embodiment is achieved by combining the first and second embodiments mentioned above, and is practiced using the system arrangement shown in FIG. 2 used in the above description. The operation of the backup program 22b in the third embodiment will be explained below with reference to the flow chart shown in FIG. 14. Note that mirroring is done as a data backup process.

In the third embodiment as well, the collation code 16a is stored in the hard disk device 16 to be set as a backup destination in the initial setup process, as described above using the flow chart shown in FIG. 10.

When the personal computer 10 is not connected to the docking base (station) 12 and is not ready to start backup, the contents of data written in the hard disk device 24 are stored using the change flag 22c and change log 22d, as has been explained previously with reference to the flow chart shown in FIG. 3 in the first embodiment.

If the hard disk device 16 is connected to the personal computer 10 (step G1), the operating system 22a is informed of generation of a connection event. Upon detecting the connection event, the operating system 22a sends to the backup program 22b a message indicating that the hard disk device 16 is connected.

Upon receiving that message from the operating system 22a (step G2), the backup program 22b reads out and confirms the collation codes 24a and 16a respectively stored in the hard disk devices 24 and 16 (step G3) and checks if the two collation codes match (step G4).

The backup program 22b checks with reference to the change flag 22c if data stored in the hard disk device 24 have been changed after the hard disk device 16 was disconnected previously (the personal computer 10 was detached from the docking station 12) (step G5).

If data stored in the hard disk device 24 have not been changed, the backup program 22b starts mirroring using the hard disk device 16 (step G10). That is, the backup program 22b writes data identical to that written in the hard disk device 24 at an identical location of the hard disk device 16 of the docking station 12.

On the other hand, if data stored in the hard disk device 24 have been changed, the backup program 22b checks if “instantaneous synchronization ON” is set (step G6). Note that the instantaneous synchronization setup has been explained in the first embodiment, and a detailed description thereof will be omitted.

If “instantaneous synchronization ON” is set, the backup program 22b copies corresponding data stored in the hard disk device 24 to a predetermined location of the hard disk device 16 in accordance with the data write contents stored in the change log 22d, thus synchronizing the hard disk devices 24 and 16 (making them store identical data) (step G7). In this case, data at a position (sector) set with “1” in the change log 22d is copied to the corresponding sector position of the hard disk device 16. Upon completion of synchronization, the contents stored in the change log 22d are cleared (all “0”s).

On the other hand, if “instantaneous synchronization OFF” is set, the backup program 22b does not execute mirroring until it receives a mirroring start instruction from the user or a mirroring start timing scheduled in advance is reached. Note that the mirroring start schedule is arbitrarily set in accordance with a user's instruction upon, e.g., setting “instantaneous synchronization OFF”.

Upon receiving a mirroring start instruction from the user (or in accordance with a schedule) while “instantaneous synchronization OFF” is set (step G8), the backup program 22b copies corresponding data stored in the hard disk device 24 to a predetermined location of the hard disk device 16 in accordance with the data write contents stored in the change log 22d, thus synchronizing the hard disk devices 24 and 16 (step G7). Upon completion of synchronization, the program 22b informs the user of backup completion by a display (not shown) (step G9) and restarts mirroring (step G10).

In this way, the third embodiment can have the effects of both the first and second embodiments mentioned above.

In the description of the respective embodiments, the backup program 22b executes mirroring with respect to the hard disk device 16. Alternatively, such a function may be provided to hardware such as an interface board (not shown) to which the hard disk device is connected to execute the aforementioned process.

In the above description, the data backup process of the hard disk device is executed. Alternatively, the present invention may be applied to the data backup process of other kinds of storage devices.

Also, in place of the storage device (hard disk device 16) mounted in the docking station 12, a storage device that can be arbitrarily connected to the personal computer 10 via a selectable bay, USB (Universal Serial Bus)/IEEE1394, or the like may be used as a backup device. In such a case, a connection event is detected using a function of detecting connection/disconnection in accordance with the connection pattern of each storage device.

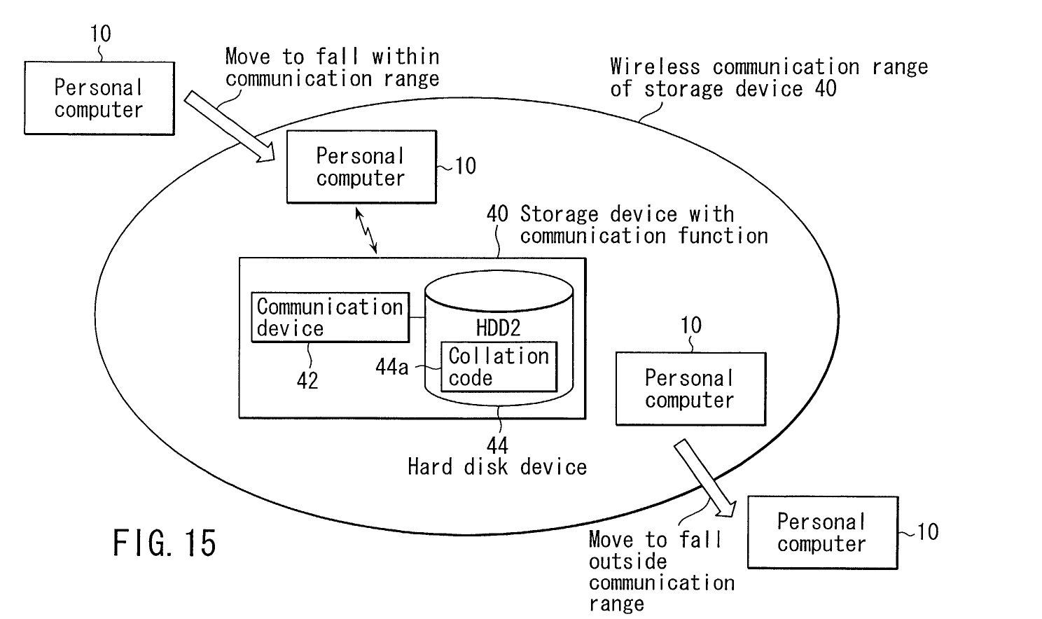

Furthermore, a storage device that can be connected via wireless communications of the communication device 32 may be used as a backup device. FIG. 15 shows a state wherein a storage device that can be connected via wireless communications is used as a backup device. In this case, a storage device 40 with a communication function is used. The storage device 40 with a communication function has a communication device 42 which can make wireless communications with the communication device 32 provided to the personal computer 10, and a hard disk device 44 for storing data exchanged via the communication device 42.

The personal computer 10 can access the hard disk device 44 when the communication device 32 and the communication device 42 in the storage device 40 with a communication function establish a communication link.

When the storage device 40 with a communication function is used as a backup device for the internal hard disk device 24 of the personal computer 10, a collation code 44a is recorded in the hard disk device 44 by the initial setup process, as has been explained above using the flow chart shown in FIG. 10.

The communication device 32 of the personal computer 10 and the communication device 42 of the storage device 40 with a communication function have a function of establishing a communication link with another communication device by recognizing each other when the apparatus moves to fall within a wireless communication range with the other communication device. Hence, when the personal computer 10 moves to fall within a communication range with the storage device 40 with a communication function, the communication device 32 detects the storage device 40 with a communication function. The communication device 32 informs the operating system 22a via its device driver that the storage device 40 with a communication function is detected. The operating system 22a informs program modules in the system of that detection result. After that, the backup program 22b executes the same process as that executed upon generation of a connection event in the second and third embodiments (see FIGS. 11 and 14). That is, the backup program 22b accesses the hard disk device 4 via a communication link established by the communication devices 32 and 42 to read out the collation code 44a stored in the hard disk device 44, and confirms if the readout collation code 44a matches the collation code 24a stored in the hard disk device 24. If the two collation codes do not match, the backup program 22b determines that the connected hard disk device 44 is not a backup device for the hard disk device 24, and ends the processing. On the other hand, if the collation code 24 of the hard disk device 24 matches the collation code 44a of the hard disk device 44, the backup program 22b executes a data backup process using the hard disk device 44 of the storage device 40 with a communication function. When the collation code 44a is not stored in the hard disk device 44, the same process as that executed upon generation of a connection event in the first embodiment may be executed (see FIG. 6).

When the personal computer 10 moves to fall outside the communication range with the storage device 40 with a communication function, the communication device 32 detects that the communication link with the storage device 40 with a communication function is disconnected. The communication device 32 informs the operating system 22a via its device driver that the storage device 40 with a communication function is disconnected. The operating system 22a informs the backup program 22b of disconnection from the storage device 40 with a communication function. The backup program 22b then executes the same process as that upon generation of a disconnection event in the first to third embodiments.

In this manner, since the storage device 40 with a communication function with which a communication link is established via wireless communications is used as a backup device without requiring any user's operations, the backup process of the internal hard disk device 24 of the personal computer 10 can be easily executed.

The data backup method described in the above embodiments may be written in storage media such as magnetic disks (flexible disk, hard disk, and the like), optical disks (CD-ROM, DVD, and the like), a semiconductor memory, and the like as a program (backup program 22b) that the computer can execute, and may be provided to various devices. Also, such a program can be delivered to various devices via communication media. A computer which implements the apparatus of the present invention executes the aforementioned process by reading the program recorded on a recording medium or receiving the program via a communication medium, and controlling its operation based on the program.

The present invention is not limited to the aforementioned embodiments, and various modifications and changes may be made without departing from the scope of the invention when it is practiced. The respective embodiments may be combined as needed as long as possible. The aforementioned embodiments include inventions of various stages, and various inventions can be extracted by appropriately combining a plurality of constituent requirements disclosed in this application. For example, even when one or a plurality of constituent requirements are deleted from all the constituent requirements disclosed in the embodiments, an arrangement from which those constituent requirements are deleted can be extracted as the invention if the effect of the present invention is obtained.

As described in detail above, according to the present invention, a detachable second storage device is used to back up data written in a first storage device, and when the second storage device is connected, the contents of data written in the first storage device are also written in the second storage device to back up the data. On the other hand, when the second storage device is not connected, the data write contents with respect to the first storage device are stored, and are backed up (copied) to the second storage device when the second storage device is connected, thus synchronizing the contents of the first and second storage devices. After that, a normal backup process using the second storage device restarts, thus implementing a data backup process using an arbitrarily detachable storage device. Hence, the data backup process can be easily done using a detachable storage device without mounting any fixed storage device for data backup.

Also, according to the present invention, since a collation code is recorded in advance in the second storage device used to back up data stored in the first storage device, only when the second storage device that records the collation code is connected, a backup process using this second storage device as a backup destination is executed. Furthermore, since the backup process starts upon detecting connection of the second storage device that records the collation code in place of starting the backup process in response to user's designation, the load on the user can be reduced. Hence, a data backup process can be easily executed without mistaking a backup destination.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus which mounts a first storage device, and to which a second storage device for data backup is connectable, said apparatus comprising:
detection unit detecting whether or not the second storage device is connected;
storage unit storing latest contents of a data write with respect to the first storage device, when said detection unit detects that the second storage device is not connected; and
backup control unit backing up the contents of the data write with respect to the first storage device, which are stored by said storage unit, to the second storage device, and thereafter backing up contents of another data write with respect to the first storage device to the second storage device, when said detection unit detects that the second storage device is connected.

2. The apparatus according to claim 1, further comprising: setting unit setting if a process for backing up the contents stored by said storage unit to the second storage device is executed instantaneously when said detection unit detects that the second storage device is connected.

3. The apparatus according to claim 1, further comprising:
collation information recording unit recording in advance, in the second storage device, collation information indicating that the second storage device is used as a data backup device; and
discrimination unit discriminating based on the collation information recorded in the second storage device if the connected storage device is the second storage device for data backup, when said detection unit detects that the second storage device is connected, and
wherein when said discrimination unit discriminates that the connected second storage device is a data backup device, said backup control unit backs up data stored in the first storage device to that second storage device.

4. A data backup method for backing up data written in a first storage device to a second storage device in an information processing apparatus to which the second storage device for data backup can be connected in addition to the first storage device which is mounted in advance, comprising the steps of:
storing, when said apparatus is not ready to back up since the second storage device is not connected, contents of a data write with respect to the first storage device; and
backing up, when it is determined that the second storage device is connected, the stored contents of the data write with respect to the first storage device to the second storage device, and thereafter backing up contents of another data write with respect to the first storage device to the second storage device.

5. The method according to claim 4, further comprising the steps of:
storing, when the contents of the data write with respect to the first storage device are stored, change information indicating that contents have been changed by the data write with respect to the first storage device; and
immediately executing, when it is determined that the second storage device is connected, and if the change information is not stored, a backup process to the second storage means.

6. The method according to claim 4, further comprising the steps of:
recording in advance, in the second storage device, collation information indicating that the second storage device is used as a backup device;
discriminating, when it is determined that the second storage device is connected, based on the collation information recorded in the second storage device if the connected storage device is the second storage device for data backup; and
backing up, when it is discriminated that the connected second storage device is a data backup device, backing up the stored contents of the data write with respect to the first storage device to the second storage device, and thereafter backing up contents of another data write with respect to the first storage device to the second storage device.

7. An information processing apparatus which mounts a first storage device, and to which a second storage device for data backup is connected, comprising:
collation information recording means for recording in advance, in an arbitrarily connectable second storage device, collation information indicating that the second storage device is used as a data backup device;
detection means for detecting if the second storage device is connected to said information processing apparatus;
discrimination means for, when said detection means detects that the second storage device is connected, discriminating based on the collation information recorded in the second storage device if the connected storage device is the second storage device for data backup; and
backup means for, when said discrimination means discriminates that the connected second storage device is a data backup device, backing up data stored in the first storage device to the second storage device.

8. An apparatus according to claim 7, wherein the second storage device can arbitrarily load/unload a storage medium, and
said collation information recording means records the collation information in the storage medium loaded into the second storage device.

9. A data backup method for backing up data written in a first storage device to a second storage device in an information processing apparatus to which the second storage device for data backup can be connected in addition to the first storage device which is mounted in advance, comprising the steps of:
recording in advance, in the second storage device, collation information indicating that the second storage device is used as a data backup device;
discriminating, when it is detected that the second storage device is connected to said information processing apparatus, based on the collation information recorded in the second storage device if the connected storage device is the second storage device for data backup; and
backing up, when it is discriminated that the connected second storage device is a data backup device, data stored in the first storage device to the second storage device.
